(19) United States
(12) Patent Application Publication
(10) Pub. No.: US 2006/0050389 A1
(43) Pub. Date: Mar. 9, 2006

(54) Polarizing reticle

(75) Inventors: Ki Ho Yang, Gyunggi-do (KR); Chun Soo Kang, Seoul (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HYNIX SEMICONDUCTOR INC., Kyungki-Do (KR)

(21) Appl. No.: 11/032,916

(22) Filed: Jan. 11, 2005

(30) Foreign Application Priority Data
Sep. 6, 2004 (KR) 2004-70930

(51) Int. Cl. G02B 5/30

(52) U.S. Cl. 359/494; 359/483

(57) ABSTRACT

A polarizing reticle including a transparent substrate, a polarizing filter formed over the transparent substrate, and a mask pattern formed on the polarizing filter. The polarizing reticle can polarize illumination light incident thereto in a desired direction in a photolithography process.

This application relies for priority upon Korean Patent Application No. 2004-70930 filed on Sep. 6, 2004, the contents of which are herein incorporated by reference in their entirety.

### BACKGROUND

1. Technical Field

The present patent relates to a reticle, and, more particularly, to a polarizing reticle capable of polarizing illumination light incident thereto in a desired direction in a photolithography process.

2. Description of the Related Art

On pace with recent trends to provide semiconductor devices having a higher integration and a higher density, active research has been performed to develop photolithography capable of forming micro patterns having a further reduced size. Meanwhile, for the manufacture of highly integrated devices, a high resolution and a high depth of focus (DOF) are required. To this end, conventional lithography techniques incorporate an immersion technique therein. In this case, however, an excessive increase in numerical aperture (NA) may occur.

When an excessive increase in NA occurs, a reduction in DOF may occur. Furthermore, in this case, there is no remarkable increase in resolution For this reason, research is being currently performed to increase both the resolution and the DOF.

A proposal has been made which uses components of illumination light polarized to meet the orientation, shape and density of patterns, in order to obtain a high resolution and a high DOF. Conventionally, such polarized light components may be produced by polarizing light emitted from a light source in a desired direction through a particular illumination mode of an illumination system, for example, an annular or dipole illumination mode.

However, the polarized illumination light beams produced in accordance with the conventional method have the same orientation as the illumination mode, irrespective of the orientation, shape and density of the patterns. As a result, although main patterns, which have the same orientation as the illumination mode, are normally formed, sub patterns, which have an orientation different from that of the illumination mode, may be abnormally formed.

Furthermore, for the production of polarized illumination light meeting the orientations, shapes and densities of all patterns, it is necessary to use separate illumination devices for respective polarization directions. However, this causes a difficulty in establishing desired diverse process conditions and providing desired equipment, taking into consideration the current technological level.

### SUMMARY

Therefore, it is an object of the patent to disclose a polarizing reticle capable of polarizing illumination light in a desired direction to produce diverse illumination light beams meeting diverse patterns. In accordance with one aspect, the present patent discloses a polarizing reticle having: a transparent substrate; a polarizing filter formed over the transparent substrate; and a mask pattern formed on the polarizing filter.

In accordance with another aspect, the present patent discloses a polarizing reticle having: a transparent substrate; a mask pattern formed on one main surface of the transparent substrate; and a polarizing filter formed over the other main surface of the transparent substrate. In accordance with yet another aspect, the present patent discloses a polarizing reticle comprising: a transparent substrate; a mask pattern formed on the transparent substrate; and a polarizing filter formed over the transparent substrate to cover the mask pattern. The mask pattern may have at least one of a shield film pattern, a phase shift film pattern, or a chromeless pattern.

### BRIEF DESCRIPTION OF THE DRAWINGS

The disclosed invention will become more apparent after reading the following detailed description when taken in conjunction with the drawings, in which:

FIG. 1 is a sectional view illustrating an exemplary polarizing reticle according to a first embodiment;

FIG. 2 is a sectional view illustrating an exemplary polarizing reticle according to a second embodiment;

FIG. 3 is a sectional view illustrating an exemplary polarizing reticle according to a third embodiment; and

FIG. 4 is a sectional view illustrating an exemplary polarizing reticle according to a fourth embodiment.

### DESCRIPTION OF THE VARIOUS EMBODIMENTS

Hereinafter, the present invention will be described in detail in conjunction with exemplary embodiments, with reference to the annexed drawings, so as to enable skilled persons in the art to readily implement the present invention. However, the present invention is not limited to the illustrated embodiments, and other embodiments may be implemented.

In order to clearly define layers and regions to be described in the following description, those layers and regions are shown in an exaggerated state, in particular, in terms of thickness, in the annexed drawings.

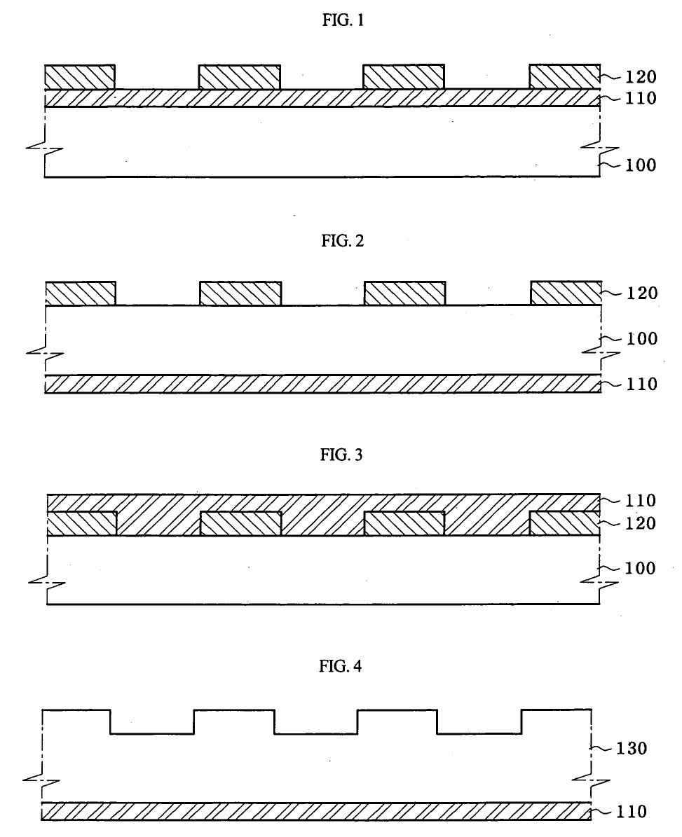

A polarizing reticle according to an exemplary embodiment will be described in detail with reference to FIG. 1. FIG. 1 is a sectional view illustrating an exemplary polarizing reticle according to a first embodiment. As shown in FIG. 1, the polarizing reticle includes a transparent substrate 100, and a polarizing filter 10 formed over the substrate 100 to have a desired orientation, and a mask pattern 120 formed on the polarizing filter 110 for formation of a desired pattern on a wafer.

The mask pattern 120 may be a shield film pattern or a phase shift pattern. Where the mask pattern 120 is a simple shield film patter, the reticle is called a “binary mask”. On the other hand, where the mask pattern 120 is a phase shift pattern, the reticle is called a “phase shift mask”. Generally, the shift film pattern is made of chromium (Cr), and the phase shift film pattern is made of molybdenum (Mo).

As described above, the polarizing reticle includes both the polarizing filter and the mask pattern on the transparent substrate, so that the polarizing reticle itself can polarize illumination light incident thereto. Accordingly, it is possible to easily produce illumination light beams meeting diverse patterns by varying the polarizing reticle to meet the shape, direction and density of each pattern without any particular process to be performed for the illumination system of the light exposure device. Because illumination light beams meeting diverse patterns can be used, it is possible to achieve an increase in margins such as resolution and DOF.

The polarizing reticle according to the illustrated embodiment is applicable to an immersion lithography process. In this case, the polarizing reticle may be used as a polarizing illumination system at a hyper NA, that is, an NA of 1.0 or more. In particular, the polarizing reticle may be used in an immersion lithography process using an Arf (wavelength of 193 nm), Krf (wavelength of 248 nm) or F2 (wavelength of 157 nm) exposure light source.

FIG. 2 is a sectional view illustrating an exemplary polarizing reticle according to an alternative embodiment In FIG. 2, constituent elements corresponding to those in FIG. 1 are denoted by the same reference numerals. As shown in FIG. 2, the polarizing reticle includes a transparent substrate 100. In accordance with this embodiment, a mask pattern 120 for formation of a desired pattern on a wafer is formed on one main surface (upper surface) of the substrate 100. A polarizing filter 110 is formed over the other main surface (lower surface) of the substrate 100 where the mask pattern 120 is not present

FIG. 3 is a sectional view illustrating an exemplary polarizing reticle according to a third embodiment In FIG. 3, constituent elements corresponding to those in FIG. 1 are denoted by the same reference numerals. As shown in FIG. 3, the polarizing reticle includes a transparent substrate 100. In accordance with this embodiment, a mask pattern 120 for formation of a desired pattern on a wafer is formed on the substrate 100. A polarizing filter 110 is formed over the substrate 100 to cover the mask pattern 120.

The polarizing reticles of the second and third embodiments illustrated in FIGS. 2 and 3 provide the same effects as those disclosed in the first embodiment.

FIG. 4 is a sectional view illustrating an exemplary polarizing reticle according to a fourth embodiment In FIG. 4, constituent elements corresponding to those in FIG. 1 are denoted by the same reference numerals. As shown in FIG. 4, the polarizing reticle includes a chromeless mask 130 having, at one main surface (upper surface) thereof a protrusion/groove structure in which protrusions and grooves are alternately repeated. A polarizing filter 110 is formed over the other main surface (lower surface) of the chromeless mask 130 where the protrusion/groove structure is not present The polarizing reticle of the fourth embodiment illustrated in FIG. 4 provides the same effects as those of the first embodiment.

Although the disclosed polarizing filter has been described in conjunction with applications to a binary mask having a simple shield film structure, a phase shift mask, and a chromeless mask, the polarizing filter may be applied to any other masks.

As apparent from the above description, a polarizing filter is incorporated in a reticle. Accordingly, it is possible to easily select the polarization direction of illumination fight meeting the orientation, shape and density of a pattern to be formed, using only the polarizing filter attached to the reticle, without using a separate illumination system adapted to polarize illumination light in a direction corresponding to the orientation of the pattern Thus, more diverse experiments may be implemented.

Thus, it is possible to achieve polarization in a higher purity, as compared to the case in which polarization is performed by the light source, because the path of the polarized illumination light where the light beam reaches the wafer after being polarized by the reticle is shorter than the path of the polarized illumination light beam where the light beam reaches the wafer after being polarized by the light source.

The polarizing reticle of the present invention can be used at a hyper NA, which is used in an immersion lithography process. Accordingly, an increase in contrast may be realized, so that it is possible to achieve improvements in process margin, resolution, and DOF.

1-6. (canceled)

7. A polarizing reticle comprising:
a transparent substrate;
a polarizing filter; and
a mask pattern.

8. The polarizing reticle according to claim 7, wherein the polarizing filter is formed over the transparent substrate and the mask pattern is formed on the polarizing filter.

9. The polarizing reticle according to claim 8, wherein the mask pattern comprises at least one of a shield film pattern, a phase shift film pattern, and a chromeless pattern.

10. The polarizing reticle according to claim 7, wherein the mask pattern is formed on one main surface of the transparent substrate and the polarizing filter is formed over the other main surface of the transparent substrate.

11. The polarizing reticle according to claim 10, wherein the mask pattern comprises at least one of a shield film pattern, a phase shift film pattern, and a chromeless pattern.

12. The polarizing reticle according to claim 7, wherein the mask pattern is formed on the transparent substrate and the polarizing filter is formed over the transparent substrate to cover the mask pattern.

13. The polarizing reticle according to claim 12, wherein the mask pattern comprises at least one of a shield film pattern, a phase shift film pattern, and a chromeless pattern.
